(19) United States
(12) Patent Application Publication
(10) Pub. No.: US 2020/0116976 A1
(43) Pub. Date: Apr. 16, 2020

(54) SINGLE-PIECE PANEL STRUCTURE HAVING TRUSS WITH ALIGNED OPENINGS

(71) Applicant: Raytheon Company, Waltham, MA (US)

(72) Inventor: Andrew L. Bullard, Manhattan Beach, CA (US)

(21) Appl. No.: 16/156,166

(22) Filed: Oct. 10, 2018

(51) Int. Cl. G02B 7/182; B23H 7/26

(52) U.S. Cl. CPC G02B 7/182; B23H 7/26

(57) ABSTRACT

A rigid panel structure made from a single piece of continuous, unitary material, includes a front plate, a back plate, and a truss structure between the plates. The truss structure includes angled non-perpendicular struts, perhaps coupled with perpendicular struts, that define a series of openings between the struts, with the openings aligned with one another in at least two different directions. The structure may be formed using electrical discharge machining (EDM), with material removed by EDM in at least two directions to create the openings between the struts of the truss structure.

### FIELD OF THE INVENTION

The invention is in the field of panel structures.

### DESCRIPTION OF THE RELATED ART

Large aperture flat mirrors used in high performance optical systems often must be light-weighted to achieve the combination of stiffness and low weight needed to minimize self-weight deflection or dynamic deflection during operation, in a fast steering mirror application, or to survive other structural loads such as would be experienced when being launched into space as part of a space electro-optical system.

Light-weighted flat mirrors are most commonly either “open-back” and traditionally machined or cast with open pockets cut from the back side to remove material, or are “closed-back,” being assembled from multiple pieces such as a face sheet, core, and back sheet. The different materials are joined by adhesive which is the weakest point and labor intensive. Closed-back mirrors achieve far higher stiffness-to-weight but are more complicated and expensive to fabricate. Another example of a closed-back mirror is a mirror in which machined front and back structures are brazed together.

In addition panel structures are used for other purposes where rigidity and low weight are important.

### SUMMARY OF THE INVENTION

A panel structure includes a front plate, a back plate, and a truss structure with aligned openings in at least two directions, with the plates and truss structure all as parts of a single continuous and unitary piece of material.

A panel structure includes a truss structure made by removing material in multiple directions using electrical discharge machining.

According to an aspect of the invention, a panel structure includes: a front plate; a back plate; and a truss structure between the front plate and the back plate. The front plate, the back plate, and the truss structure are parts of a continuous, unitary, single piece of material. The truss structure includes struts defining aligned openings, with openings aligned in at least two directions parallel to at least one of the plates.

According to an embodiment of any paragraph(s) of this summary, the openings are triangular openings.

According to an embodiment of any paragraph(s) of this summary, the triangular openings are isosceles-triangle shaped.

According to an embodiment of any paragraph(s) of this summary, the triangular openings are scalene-triangle shaped.

According to an embodiment of any paragraph(s) of this summary, the openings are trapezoidal.

According to an embodiment of any paragraph(s) of this summary, at least some of the struts are angled in a non-perpendicular relationship to the plates.

According to an embodiment of any paragraph(s) of this summary, the panel structure is made of beryllium or an alloy of beryllium.

According to an embodiment of any paragraph(s) of this summary, the panel structure is made of aluminum or titanium.

According to an embodiment of any paragraph(s) of this summary, the openings are aligned in three directions.

According to an embodiment of any paragraph(s) of this summary, the panel structure is an optical device.

According to an embodiment of any paragraph(s) of this summary, the panel structure is a mirror.

According to an embodiment of any paragraph(s) of this summary, a front surface of the front plate, facing away from the truss structure, is a polished surface.

According to an embodiment of any paragraph(s) of this summary, a front surface of the front plate, facing away from the truss structure, is a plated surface.

According to an embodiment of any paragraph(s) of this summary, the front plate is parallel to the back plate.

According to an embodiment of any paragraph(s) of this summary, the struts each have a cross-section of 1 mm square or less.

According to an embodiment of any paragraph(s) of this summary, the struts have thickened bases where they connect to the plates.

According to an embodiment of any paragraph(s) of this summary, the thickened bases are pyramidal in shape.

According to an embodiment of any paragraph(s) of this summary, the back plate has cut-outs therein.

According to another aspect of the invention, a method of making a panel structure includes the steps of: providing a single piece of material; and removing some of the material to create openings that are aligned in multiple directions, thereby creating the panel structure with a truss structure between a front plate and a back plate. The truss structure and the plates are all parts of the single piece of material.

According to an embodiment of any paragraph(s) of this summary, the removing includes removing material in at least three directions.

According to an embodiment of any paragraph(s) of this summary, the removing includes electrical discharge machining to create the openings.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various aspects of the invention.

FIG. 1 is an oblique view of a panel structure in accordance with an embodiment of the invention.

FIG. 2 is a side view of the panel structure of FIG. 1.

FIG. 3 is a detailed view of part of the truss of the panel structure of FIG. 1.

FIG. 4 is an oblique view of a panel structure in accordance with another embodiment of the invention.

FIG. 5 is a plan view of the panel structure of FIG. 4.

FIG. 6 is a side view of the panel structure of FIG. 4.

FIG. 7 is a high-level flow chart of a method of making a panel structure, according to an embodiment of the invention.

### DETAILED DESCRIPTION

A rigid panel structure made from a single piece of continuous, unitary material, includes a front plate, a back plate, and a truss structure between the plates. The truss structure includes angled non-perpendicular struts, perhaps coupled with perpendicular struts, that define a series of openings between the struts, with the openings aligned with one another in at least two different directions. The structure may be formed using electrical discharge machining (EDM), with material removed by EDM in at least two directions to create the openings between the struts of the truss structure.

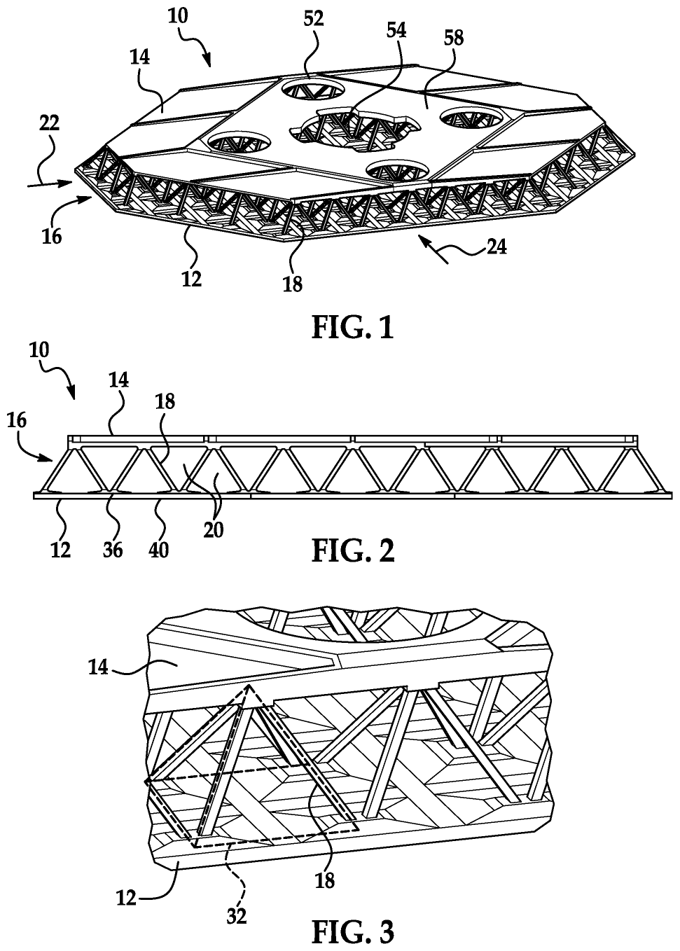

FIGS. 1-3 show a rigid panel structure 10 that is made by a subtractive manufacturing process, removing material from a single block of material, leaving the single-piece, unitary, continuous rigid structure 10. The rigid structure 10 includes a front plate 12, a back plate 14, and a truss structure 16 between the front plate 12 and the back plate 14. In the illustrated embodiment the plates 12 and 14 are parallel to each other. The truss structure 16 includes a series of struts 18 running between the plates 12 and 14, with the struts 18 angled so as to be non-perpendicular to the plates 12 and 14. In other embodiments some of the struts 18 may be perpendicular to the plates 12 and/or 14, for example with the struts 18 being a combination of perpendicular and non-perpendicular struts, such as with perpendicular struts alternating with non-perpendicular struts. The panel structure 10 is a closed-back truss structure in that the back plate 14 covers at least most of the back of the truss structure 16.

The struts 18 define openings 20 between adjacent of the struts 18. The openings 20 in the illustrated embodiment are triangular. In other embodiments the openings may have other shapes, for example being trapezoidal or rectangular. In the illustrated embodiment the openings 20 have isosceles triangle shapes, but alternatively they may have other shapes, such as scalene triangles. The struts 18 may form a series of repeating pyramidal truss elements (or portions), such as the truss element 32 shown in FIG. 3. The openings 20 are aligned in a pair of orthogonal directions 22 and 24. The directions 22 and 24 are parallel to the plates 12 and 14, which are parallel to each other. The openings 20 may be formed by subtracting manufacturing processes, in which material is removed from a piece, which is contrasted with additive manufacturing processes in which an object if formed by adding material. The openings 20 may be formed by electrical discharge machining (EDM) in the directions 22 and 24.

The thickness of the plates 12 and/or 14 may be varied to better support the struts 18. For example the back plate 14 may have greater thicknesses at locations 36 where the struts 18 connect to the back plate 14. The thickened base locations 36 may themselves form pyramidal structures at the bases of the struts 18, with the base pyramids being shallower than the truss portions 32.

The use of EDM may allow fine control of the dimensions of the struts 18, with the dimensions of the struts 18 finer and better controlled (more consistent throughout the length of the struts 18) than is generally available with additive manufacturing processes. The struts 18 may have square cross sections, although other cross-sectional shapes may be possible. To give example values, the struts 18 may be 3 mm square (3 mm×3 mm) or less, may be 1 mm square or less, may be 0.5 mm or less, and/or may be ranges involving any two of those values (0.5-1 mm square, 0.5-3 mm square, or 1-3 mm square).

The plates 12 and 14 may have any of a variety of suitable thicknesses. To give a non-limiting range, the plates 12 and 14 may each have thicknesses of 1-4 mm.

The rigid structure 10 may be made of any of a variety of suitable materials. Non-limiting example materials include metallic materials such as aluminum, beryllium, titanium, or beryllium-aluminum alloys, and non-metallic materials, such as silicon carbide. Silicon carbide materials may be machined while in a graphite state, and then converted into silicon carbide by substitution of silicon atoms for some of the carbon atoms of the graphite, although as an alternative another order of process steps may be possible. Some of these materials may not be feasible candidates for an additive manufacturing process. At least some of the surface of the rigid structure 10 may be coated or plated with another material, such as silicon, nickel, or a ceramic material. The coating (or plating) may be used to provide desirable optical characteristics, such as for a mirrored surface.

The rigid panel structure 10 may be an optical device, such as a mirror. In such a device a front surface 40 of the front plate 12 may be plated and/or polished to achieve suitable optical characteristics.

Alternatively the rigid panel structure 10 may be or may be part of other sorts of devices. For example platforms for semiconductor device production may involve use of lightweight rigid structures.

The back plate 14 may have machined features provided for different purposes. There may be openings, such as apertures 52 for receiving tilt actuators for tilting the structure 10, and/or for mounting the rigid structure 10, and an aperture 54 for receiving a tilt sensor that detects the tilt of the rigid structure 10. In addition there may be openings for other purposes, such as for weight reduction. The back plate 14 may have a non-uniform thickness, such as in the illustrated embodiment, which has a thicker portion 58 around the openings 54. The thicker portion 58 may provide additional local stiffness, making up for the removal of material in the openings in the back plate 14.

It will be appreciated that there may be additional or alternative machined features on the back plate 14 (and/or the front plate 12). The various machined features should not be configured so as to interfere with removal of material to create the truss structure 16.

The rigid panel structure 10 may be any of a variety of suitable sizes. To give non-limiting example values, the structure 10 may have a length extent (or diameter) of from 7.5 cm (3 inches) to 60 cm (24 inches). More narrowly the length extent may be from 30.5 cm (12 inches) to 38 cm (15 inches).

There may be any of a variety of suitable shapes for the panel device 10. The device may be round or polygonal, with any of a variety of polygon shapes.

The rigid panel structure 10 offers many advantages over prior approaches to making rigid devices such as optical devices. Having the panel structure 10 made as a single piece improves structural integrity. In addition the single-piece configuration does away with any need to join together parts of a panel structure, such as by bonding, welding, etc. The panel structure 10, being made all of a single material, has a single coefficient of thermal expansion, and therefore reacts well to temperature changes, not having any internal stress due to discrepancies in coefficient of thermal expansion.

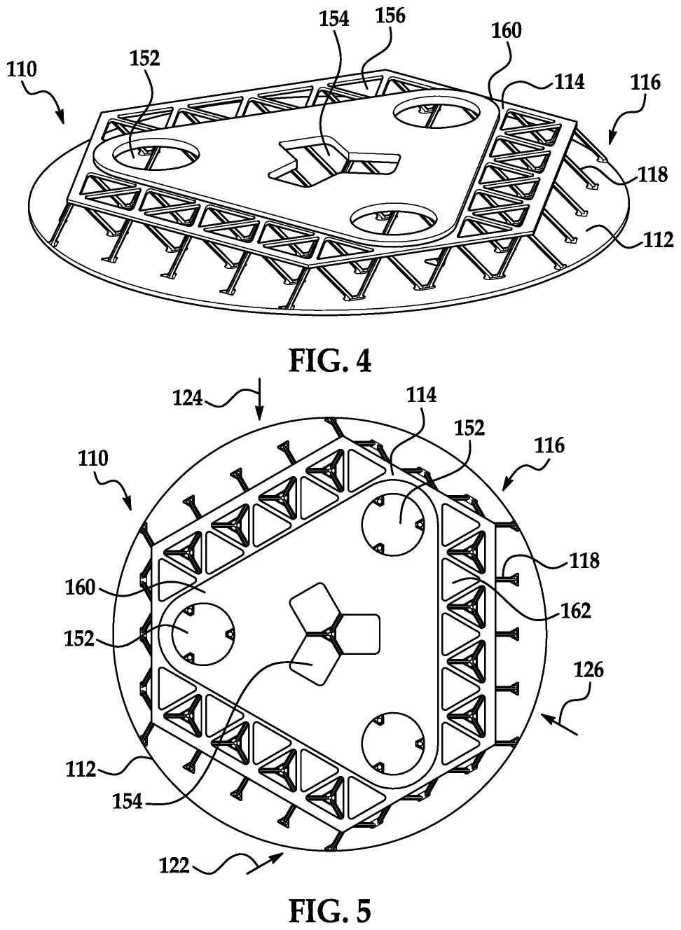

FIGS. 4-6 show another embodiment, a rigid panel structure 110 which has a front plate 112, a back plate 114, and a truss structure 116 that is formed by removing material in three directions. This results in a tetrahedronal (triangular pyramidal) cell arrangement of struts 118 of the truss structure 116, which contrasts with the rectangular-base pyramid strut cells of the panel structure 10 (FIG. 1), for which material is removed in only two directions.

Struts 118 of the truss structure 116 are defined by openings 120 that are aligned in three directions 122, 124, and 126. The directions 122-126 are parallel to the plates 112 and 114, and are offset from one another by 120 degrees. Other arrangements of the directions 122-126 may be possible, with different angles between adjacent of the directions 122-126.

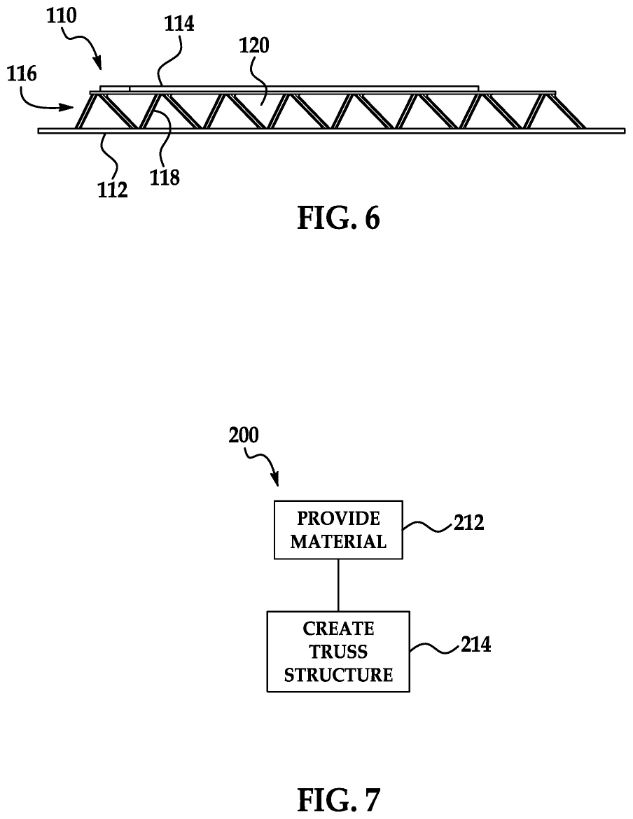

The openings 120 may have an asymmetric saw tooth pattern as seen from the side, such as shown in FIG. 6. The struts 118 may have the appearance of unequal lengths and unequal angles when projected in certain directions relative to the plates 112 and 114. This arrangement may be made in order to ensure that the struts 118 connect the plates 112 and 114 after the cuts, such as by EDM, in the different directions 122-126. The illustrated pattern may be stretched in one or more of the lateral directions, to achieve desired dimensions and characteristics for the truss structure 116.

The back plate 114 includes machined features such as apertures 152 and 154 for mounting the structure 110, or for attaching actuators, flexures, or other hardware, such as tilt sensors. Cutouts 156 are also provided in the back plate 114 for weight reduction purposes. A central area 160 of the back plate 114, where the apertures 152 and 154 are located, is thicker than a peripheral region 162 where the cutouts 156 are located.

The three-way rigid panel structure 110 offers stiffness and weight characteristics that are on a par with those of the two-way rigid panel structure 10 (FIGS. 1-3). In addition the structure 110 provides an advantage over the structure 10 in that three-way symmetry is better for true kinematic mounting.

FIG. 7 shows a high-level flow chart of steps of a method 200 for producing a rigid panel structure such as the panel structures 10 and 110 described above. In step 212 a block of material is provided, out of which the panel structure 10, 110 is to be made. In step 214 the truss structure 16, 116 is created by removing material from aligned openings 20, 120 in at least two directions 22, 122, 24, 124, and/or 126, for example by using EDM. Other steps, such as plating, polishing, and/or machining, may also be performed.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A panel structure comprising:
a front plate;
a back plate; and
a truss structure between the front plate and the back plate;
wherein the front plate, the back plate, and the truss structure are parts of a continuous, unitary, single piece of material; and
wherein the truss structure includes struts defining aligned openings, with openings aligned in at least two directions parallel to at least one of the plates.

2. The panel structure of claim 1, wherein the openings are triangular openings.

3. The panel structure of claim 2, wherein the triangular openings are isosceles-triangle shaped.

4. The panel structure of claim 2, wherein the triangular openings are scalene-triangle shaped.

5. The pane structure of claim 1, wherein the openings are trapezoidal.

6. The panel structure of claim 1, wherein at least some of the struts are angled in a non-perpendicular relationship to the plates.

7. The panel structure of claim 1, wherein the panel structure is made of beryllium or an alloy of beryllium.

8. The panel structure of claim 1, wherein the panel structure is made of aluminum or titanium.

9. The panel structure of claim 1, wherein the openings are aligned in three directions.

10. The panel structure of claim 1, wherein the panel structure is an optical device.

11. The panel structure of claim 1, wherein the panel structure is a mirror.

12. The panel structure of claim 11, wherein a front surface of the front plate, facing away from the truss structure, is a polished surface.

13. The panel structure of claim 11, wherein a front surface of the front plate, facing away from the truss structure, is a plated surface.

14. The panel structure of claim 1, wherein the front plate is parallel to the back plate.

15. The panel structure of claim 1, wherein the struts each have a cross-section of 1 mm square or less.

16. The panel structure of claim 1, wherein the struts have thickened bases where they connect to the plates.

17. The panel structure of claim 16, wherein the thickened bases are pyramidal in shape.

18. The panel structure of claim 1, wherein the back plate has cut-outs therein.

19. A method of making a panel structure, the method comprising:
providing a single piece of material; and
removing some of the material to create openings that are aligned in multiple directions, thereby creating the panel structure with a truss structure between a front plate and a back plate;
wherein the truss structure and the plates are all parts of the single piece of material.

20. The method of claim 19, wherein the removing includes removing material in at least three directions.
